(19) United States
(12) Patent Application Publication
(10) Pub. No.: US 2008/0298622 A1
(43) Pub. Date: Dec. 4, 2008

(54) Headphones with Detachable Headband

(76) Inventor: Johann Lee, Maspeth, NY (US)

Correspondence Address: MAYER BROWN LLP, P.O. BOX 2828, CHICAGO, IL, 60690, US

(21) Appl. No.: 12/159,851

(22) PCT Filed: Jan. 3, 2007
(86) PCT No.: PCT/US2007/060052

§ 371 Date: Jul. 1, 2008

Related U.S. Application Data
(60) Provisional application No. 60/755,768, filed on Jan. 4, 2006.

(51) Int. Cl. H04R 1/10

(52) U.S. Cl. 381/378

(57) ABSTRACT

A pair of earphones designed to be worn in or on the ear of a user, comprising at least one element for connecting a headband; a pair of ear clips or ear buds comprising a removably-attached headband; and a kit comprising (i) a pair of earphones designed to be worn in or on the ear of a user, comprising at least one element for connecting a headband; and (ii) a headband designed to be connected to said pair of earphones is provided.

### PRIORITY INFORMATION

This application claims priority of Provisional Application Ser. No. 60/755,768 filed on Jan. 4, 2006.

### FIELD OF THE INVENTION

This invention relates generally to audio components, and more particularly to headphone or earphone devices that include a removable headband.

### BACKGROUND OF THE INVENTION

Headphones and earphones for electronic devices are increasingly being used by individuals in a variety of settings and during a variety of activity types. In particular, for example, an individual may use headphones both while exercising and while commuting to and from work.

To date, few headphones are designed in such a manner that they function well for use during all activity types. Wrap-around headphones, for example, are typically better-adapted (than are ear clips and ear buds) for use during exercise, because the wrap-around headband element of the wrap-around headphones prevents slippage and slip-out of the earphones from a user's ears when the headphones jostle during exercise. Ear clips and ear buds, on the other hand, are typically better-adapted (than are wrap-around headphones) for activities that do not necessitate as much protection from slippage and slip-out (e.g., commuting or traveling) because of their less bulky, more comfortable, and more easily-stowable design.

Accordingly, there exists a need for improvement in the design of headphones and earphones, such that the performance of the headphones across different activity types is increased. The present invention meets this need and others, as will be apparent to those of skill in the art.

### SUMMARY OF THE INVENTION

According to one aspect of the present invention, there is provided a pair of earphones designed to be worn in or on the ear of a user, comprising at least one element for connecting a headband.

In another embodiment, there is provided a pair of ear clips or ear buds comprising a removably-attached headband.

In yet another embodiment, there is provided a kit comprising (i) a pair of earphones designed to be worn in or on the ear of a user, comprising at least one element for connecting a headband; and (ii) a headband designed to be connected to said pair of earphones is provided.

An advantage of the present invention is that it eliminates the need by users to buy and use different types of headphones during different activity types.

Another advantage of the present invention is that it provides users with a product that is flexible in its configuration and is, thereby, more generally useful to a user.

Another advantage of the present invention is that it provides users who are traveling with both an active/sport pair of headphones and a more causal, comfortable pair of earphones, in one product.

These and other aspects and advantages will become apparent to those of ordinary skill in the art by reading the following detailed description, with reference where appropriate to the accompanying drawings. Further, it should be understood that the foregoing summary is merely exemplary and is not intended to limit the scope of the invention as claimed.

### BRIEF DESCRIPTION OF THE DRAWINGS

FIG. 1a illustrates a perspective view of headphones in accordance with an embodiment of the present invention.

FIG. 1b illustrates a perspective view of headphones in accordance with an embodiment of the present invention.

FIG. 2 illustrates a exploded view of the first and second connecting members of the headband and earphones.

FIG. 3 illustrates a side elevation view of earphones in accordance with an embodiment of the present invention in use by a user.

FIG. 4 illustrates a side elevation view of earphones and attached headband in accordance with an embodiment of the present invention in use by a user.

### DETAILED DESCRIPTION

Headphones, earphones and a kit are disclosed. In the following description, numerous specific details are set forth in order to provide a thorough understanding of the present invention. It will be understood, however, to one skilled in the art, that the present invention may be practiced without some of these specific details. In other instances, well known process operations have not been described in detail in order not to unnecessarily obscure the present invention.

As used herein, a “headband” is defined to mean any element of sufficient size and shape that adjoins an earphone that is situated on, positioned on, or secured to one ear of a user, around any portion or region of the user's head or neck (e.g., above-the-head, behind-the-head or behind-the-neck), to an earphone that is positioned on the opposite ear of the user.

“Earphones”, as discussed more fully below, are defined herein to mean any pair of earphones that can be placed on or near the ears of a user and which function to reproduce the sound of a digital or non-digital device (e.g., such as, for example, a portable music player (PMP) such as an iPOD™ digital storage device, a portable digital assistant (PDA), a digital camera, a telephone, a portable DVD player, an all-in-one device combining more than one functionality, or the like), either by wired communication or by wireless communication.

“Ear clips” are defined to mean an earphone having an element that wraps around (or follows the contour of) at least a portion of the ear.

“Ear buds” are defined to mean any earphones that can be substantially secured, secured, held, positioned, or inserted within (or at least partially within) either the concha or ear canal of the ear of a user.

“Headphones” are defined herein to mean any pair of earphones, ear clips or ear buds that are connected by a headband.

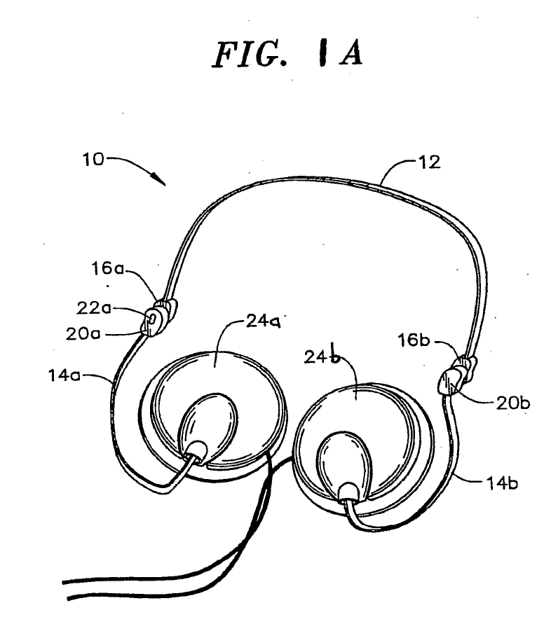

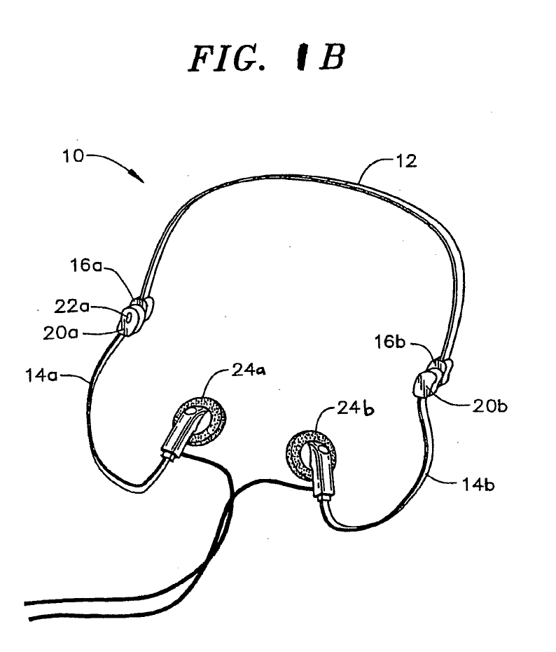

FIGS. 1a and 1b illustrate headphones 10 in accordance with an embodiment of the present invention. In particular, the headphones 10 are shown to comprise a headband 12 having two first connecting elements, 16a and 16b (collectively “16”).

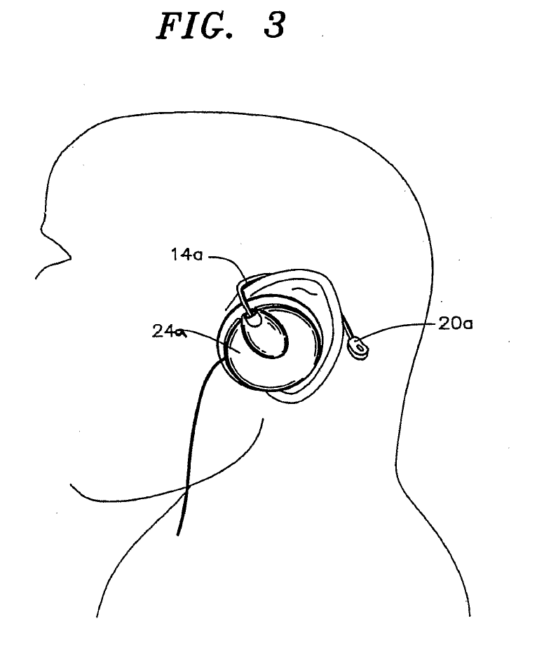

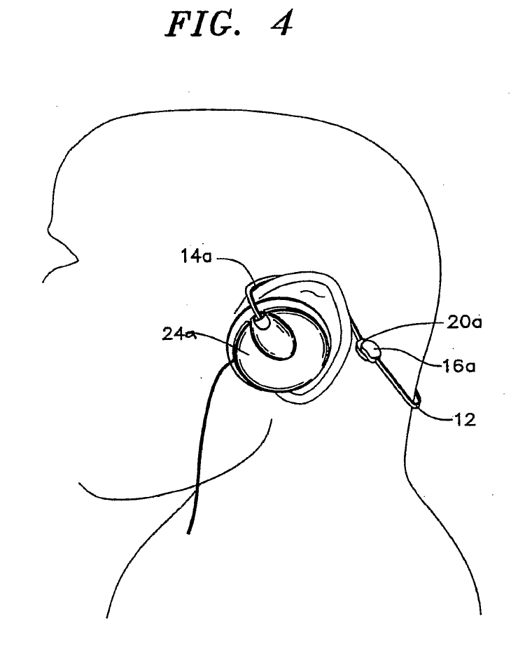

Moreover, the headphones 10 are shown to comprise a pair of earphones, 24a and 24b (collectively “24”), that each comprise a curved body (or wrap-around element), 14a and 14b (collectively “14”), that is designed to wrap around at least a portion of the ear of a user (as illustrated in FIGS. 3 and 4), and a second connecting element, 20a and 20b (collectively “20”), that is designed to removably connect to the first connecting elements 16, respectively.

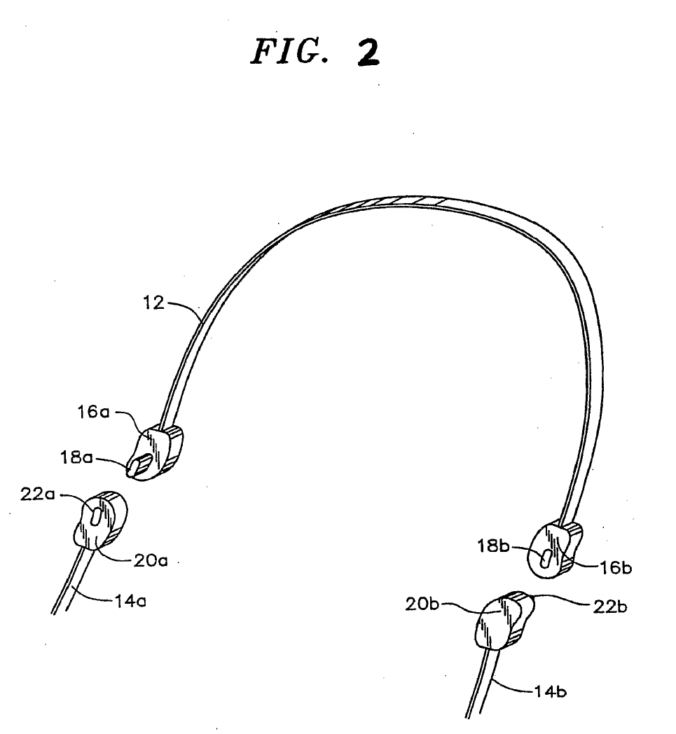

The first connecting elements 16 and the second connecting elements 20 can be removably attached or connected to each other using any suitable mechanism, as discussed more fully below with respect to FIG. 2. In this regard, while the Figures depict the first and second connecting elements as being removably attached to each other via a male-female configuration, this is only one example of a suitable mechanism for removable attachment.

FIGS. 1a and 1b, in this regard, partially depict a “female” connecting member 22a that is housed within the second connecting element 20a of earphone 24a. A better illustration of this example removable-attachment mechanism is offered in FIG. 2.

As discussed above, the headband 12 can be any element (e.g., wrap-around, unshaped, curved or curvilinear element) of sufficient size and shape to extend from an earphone 24a that is positioned on one ear of a user, around any portion or region of the user's head or neck (e.g., above-the-head, behind-the-head or behind-the-neck) (visible only in FIGS. 3 and 4), to an earphone 24b that is positioned on the other ear of the user. The headband 12 can be firm or flexible in nature, or a portion may be flexible and a portion may be rigid. Moreover, the headband 12 can be constructed of any suitable material, such as, for example, metal (e.g., a malleable metal, such as malleable stainless steel), plastic, fibrous, polymers, rubber, foam, fabric, or the like. Moreover, the length and/or shape of the headband element can be adjustable or changeable, e.g., to fit the head of a user.

The earphones 24 can be any suitable size, as discussed briefly above, and as illustrated in FIGS. 1a and 1b. In particular, for example, the earphones 24 can be any earphone that is designed to be worn in, on, or over the ear of a user. The earphones 24, in this regard, can be in the form of an ear clip, an ear bud, or any other form that can be securely positioned on or in the ear of a user, e.g. without the presence of structural components that extend or project substantially away from the ear. Portions of the earphones 24 can partially cover, cover, or project into the ear canal of a user. Irrespective of the specific electronic hardware within the earphones 24 for reproducing audio, the earphones 24 preferably are positionable by a user to maximize comfort. The earphones 24, in this regard, can also be constructed of any suitable material(s), such as, for example, metal (e.g., a malleable metal, such as malleable stainless steel), plastic, fibrous, polymers, rubber, foam, fabric, or the like.

The earphones 24 can wireless transmitter/receiver devices, so that the earphones 24 can wirelessly communicate with each other and/or with other wireless devices (such as, Bluetooth™-enabled devices). In another embodiment, the earphones 24 share a wired electric source, but collectively communicate wirelessly with other wireless devices.

FIG. 2 offers an expanded view of a detached headband 12 having two first connecting elements 16a and 16b, in proximity to portions of the curved bodies 14a and 14b of the earphones 24a and 24b (not illustrated in FIG. 2), respectively. The curved bodies 14a and 14b are each shown to comprise second connecting elements 22a and 22b, respectively. As illustrated in FIG. 2, first connecting element 16a and second connecting element 22a possess corresponding curved overall shapes and possess “male” and “female” connecting members 18a and 22a, respectively, that are correspondingly curved in shape as well. Moreover, FIG. 2 depicts first connecting element 16b and second connecting element 22b as possessing corresponding curved overall shapes and as possessing “male” and “female” connecting members 18b and 22b, respectively, that are correspondingly curved in shape.

The first and second connecting elements can have any suitable corresponding shapes that collectively create a mechanical connection fit between the elements, and which function to orient the headband 12 and earphones 24 in a desired configuration with respect to each other. In particular, for example, despite the specific orientation depicted in FIG. 2, it is suitable for all “male” connecting members to be situated on, or housed within, the first connecting elements 16 of the headband 12 and for all “female” connecting members to be situated on, or housed within, the second connecting members 22 of the earphones 24. Alternatively, it is suitable for all “female” connecting members to be situated on, or housed within, the first connecting elements 16 of the headband 12 and for all “male” connecting members to be situated on, or housed within, the second connecting members 22 of the earphones 24. Moreover, the first and second connecting elements can collectively form a snap-fit, a friction-fit, or a clamping, clasping or wrapping mechanism. The curved shapes of the first and second connecting elements illustrated in FIG. 2, as well as the curved shapes of the connecting members are only one example of a suitable corresponding structure and shape. Such corresponding “curved” structures can function, however, to form a curved connection point that transitions a vertically-downward curving body 14 of an ear clip 24 into a more horizontally-extending headband 12 (as better illustrated in FIGS. 3 and 4).

FIGS. 3-4 illustrate an ear clip 24a having a wrap-around element 14a and a second connecting element 20a that is wrapped around at least a portion of the ear of a subject, with and without a headband 12 having a first connecting element 16a attached, respectively. These figures, in this manner, illustrate alternative configurations of the earphones 24 for use by a user. In particular, a user can select between wearing earphones 24 discretely without an attached headband or in combination with the headband 12. A kit is provided, is this regard, which comprises a pair of earphones designed to be worn in or on the ear of a user, comprising at least one element for connecting a headband; and a headband designed to be connected to said pair of earphones.

While this invention has been described in terms of several preferred embodiments, there are alterations, permutations, and equivalents that fall within the scope of this invention. It should also be noted that there are alternative ways of implementing both the process and apparatus of the present invention. It is therefore intended that the appended claim includes all such alterations, permutations, and equivalents as fall within the true spirit and scope of the present invention.

1-13. (canceled)

14. A pair of earphones designed to be worn in or on the ear of a user, comprising at least one second connecting element for connecting a headband.

15. The earphones of claim 14 wherein the earphones comprise a curved body designed to wrap around at least a portion of an ear.

16. The earphones of claim 14 wherein the earphones are selected from the group including ear clips and ear buds.

17. The earphones of claim 14 wherein the at least one second connecting element has a curved overall shape that is designed to connect to a substantially horizontally-oriented headband.

18. The earphones of claim 14 wherein at least one second connecting element comprises a post element designed for insertion into a receiving aperture element.

19. The earphones of claim 14 wherein the earphones further comprise at least one additional connecting element for connecting an ornamental body.

20. The earphones of claim 14 wherein the earphones are designed to communicate wirelessly with at least one other device

21. A pair of earphones comprising a removably-attached headband.

22. The earphones of claim 21, wherein the headband comprises at least one first connecting element that is removably-attached to at least one second connecting element on the ear clips or ear buds.

23. The earphones or ear buds of claim 22, wherein the first and second connecting elements have correspondingly-curved shapes.

24. A kit comprising:
a pair of earphones designed to be worn in or on the ear of a user, comprising at least one second connecting element for connecting a headband; and
a headband designed to be connected to said pair of earphones.

25. The kit of claim 24 wherein the headband comprises at least one first connecting element that is removably-attached to the at least one second connecting element on the earphones.

26. The kit of claim 25 wherein the first and second connecting elements have correspondingly-curved shapes.

27. The earphones of claim 24 wherein the earphones comprise a curved body designed to wrap around at least a portion of an ear.

28. The earphones of claim 24 wherein the earphones are selected from the group including ear clips and ear buds.

29. The earphones of claim 24 where the headband is substantially horizontally oriented.

30. The earphones of claim 24 wherein at least one second connecting element has a curved overall shape.

31. The earphones of claim 24 wherein at least one second connecting element comprises a post element designed for insertion into a receiving aperture element.

32. The earphones of claim 24 wherein the earphones further comprise at least one additional element for connecting an ornamental body.

33. The earphones of claim 24 wherein the earphones are designed to communicate wirelessly with at least one other device.
